(19) United States
(12) Patent Application Publication
(10) Pub. No.: US 2021/0032487 A1
(43) Pub. Date: Feb. 4, 2021

(54) INKJET INKS FOR TEXTILE PRINTING

(71) Applicant: Hewlett-Packard Development Company, L.P., Spring, TX (US)

(72) Inventors: Dennis Z. Guo, San Diego, CA (US); Jie Zheng, San Diego, CA (US)

(21) Appl. No.: 17/049,151

(22) PCT Filed: Jun. 14, 2018
(86) PCT No.: PCT/US2018/037580

§ 371 Date: Oct. 20, 2020

(51) Int. Cl. C09D 11/322; D06P 1/52; B41M 7/00; D06P 5/20; D06P 5/30; C09D 11/033; B41M 5/00; C09D 11/037; C09D 11/104; D06P 3/60; D06P 3/04; D06P 3/54; D06P 3/26

(52) U.S. Cl. CPC C09D 11/322; D06P 3/26; B41M 7/009; D06P 5/2077; D06P 5/30; C09D 11/033; B41M 5/0047; B41M 5/0064; B41M 5/0023; C09D 11/037; C09D 11/104; D06P 1/5285; D06P 3/6033; D06P 3/043; D06P 3/54; D06P 1/5271

(57) ABSTRACT

An example of an inkjet ink for textile printing includes a self-dispersed pigment. The self-dispersed pigment includes a pigment and an organic group attached thereto, the organic group including at least one phosphorus-containing group. The inkjet ink also includes a poly-ester-polyurethane binder and a liquid vehicle. The inkjet ink may be used in a printing method and/or in a textile printing kit.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components.

FIG. 1 is a schematic illustration of an example of a self-dispersed pigment suitable for use in an example of an inkjet ink disclosed herein;

FIG. 2 illustrates an example of a printing method; and

FIG. 3 is a schematic diagram of an example of a printing system.

### DETAILED DESCRIPTION

The textile market is a major industry, and printing on textiles, such as cotton, polyester, etc., has been evolving to include digital printing methods. However, the vast majority of textile printing 95%) is still performed by analog methods, such as screen printing. Multi-color printing with analog screen printing involves the use of a separate screen for each color that is to be included in the print, and each color is applied separately (with its corresponding screen). In contrast, digital inkjet printing can generate many colors by mixing basic colors in desired locations on the textile, and thus avoids the limitations of analog screen printing.

Disclosed herein is a pigmented inkjet ink that is suitable for digital inkjet printing on a variety of textile fabrics, including cotton, polyester, nylon, and silk. The inkjet ink disclosed herein includes a self-dispersed pigment including a pigment and an organic group attached thereto, the organic group including at least one phosphorus-containing group, and a polyester-polyurethane binder. It has been found that the example inks disclosed herein generate prints having a desirable optical density and washfastness, especially when printed on polyester textiles. It has also been found that the inks disclosed herein may also generate suitable prints on cotton, nylon, or silk.

With any of the textile fabrics disclosed herein, including polyester, the desirable optical density is achieved without having to first treat the fabric with a pre-treatment formulation and/or without having to increase the pigment loading. It has been found that the optical density of the prints formed with the inks disclosed herein on polyester, nylon and silk is higher than the optical density of prints formed with comparative pigmented inks that include pigment dispersions dispersed by a styrene acrylic polymeric dispersant. It has also been found that the optical density of the prints formed with the inks disclosed herein on polyester and nylon is higher than the optical density of prints formed with comparative pigmented inks that include self-dispersed pigments with attached small molecules that include carboxylic and/or sulfonic groups.

“Washfastness,” as used herein, refers to the ability of a print on a fabric to retain its color after being exposed to washing. Washfastness can be measured in terms of ΔE. The term “ΔE,” as used herein, refers to the change in the L*a*b* values of a color (e.g., cyan, magenta, yellow, black, red, green, blue, white) after washing. ΔE can be calculated by different equations, such as the CIEDE1976 color-difference formula and the CIEDE2000 color-difference formula, both of which are set forth in the Examples section herein. As will be discussed in the Examples section, it has been found that the washfastness of the prints formed with the inks disclosed herein on polyester and nylon is better than prints formed with comparative pigmented inks that include a styrene acrylic polymeric dispersant.

Moreover, the inkjet ink disclosed herein can be directly printed on the textile fabric, and thus examples of the printing method do not involve a transfer process. As such, the printing method may be streamlined when compared to digital printing methods that utilize dye sublimation inks and sublimation heat transfer papers. The pigments disclosed herein can also be fixed into the various fabrics at lower temperatures than the temperatures involved with dye sublimation textile printing.

Still further, the inkjet ink disclosed herein also exhibits good stability. Stability performance can be measured in terms of physical stability. The term “physical stability,” as referred to herein, means the ability of the pigment particles in the inkjet ink to remain substantially unchanged over time. To determine the physical stability of an ink, the change in particle size may be measured over time, and the percentage of size change may be determined. The particle size may be considered to be “substantially unchanged over time” when the percentage of size increase is 10% or less.

To facilitate the measurement of the particle size percentage change, the ink formulations may be stored in an accelerated storage (AS) environment. The particle size may be measured before and after the ink formulations have been stored in the accelerated storage environment. The accelerated storage environment may be an environment that has a temperature ranging from about 45° C. to about 60° C. In an example, the accelerated storage environment is an oven baked at a temperature of about 60° C. and the ink formulations are stored in the accelerated storage environment for about one week.

An additional way to facilitate the measurement of the particle size percentage change is to subject the ink formulations to a freeze-thaw or Temperature-cycle (T-cycle) condition. A T-cycle test may indicate an instability in the ink formulations that is not indicated by an accelerated storage environment test. Conversely, an accelerated storage environment test may indicate an instability in the ink formulations that is not indicated by a T-cycle test. A stable ink formulation should be able pass both an AS environment test and a T-cycle test. When conducting a T-cycle test, the particle size may be measured before and after the ink formulations have undergone the T-cycle. The T-cycle may involve heating the ink formulation to a high temperature and maintaining the ink formulation at the high temperature for a few hours, and then cooling the ink formulation to a low temperature and maintaining the ink formulation at the low temperature for a few hours. The process may be repeated for a number of cycles (e.g., 5).

A large particle size increase can lead to a short shelf life of the ink formulation. As one example, a large particle size increase may result from phase separation in the bulk ink (e.g., pigments separating from the vehicle, agglomerating with one another, and/or settling), which would cause the ink to be unusable. Further, a large particle size increase may accelerate pigment settlement due to gravity and the increased mass of the particles (as compared to the mass of the particle before the size increase). A large particle size increase may also alter the jettability performance and/or the image quality performance. Pigment agglomeration and/or settling may render the ink more difficult to jet.

The inks disclosed herein are suitable for thermal inkjet printing. It is to be understood however, that amounts of some of the components of the inks, including water and co-solvent amounts, may be adjusted to generate an ink that can be printed via piezoelectric inkjet printing.

Inkjet Ink

An example of the inkjet ink for textile printing comprises a self-dispersed pigment including a pigment and an organic group attached thereto, the organic group including at least one phosphorus-containing group, a polyester-polyurethane binder and a liquid vehicle.

The inkjet ink for textile printing includes the self-dispersed pigment. The self-dispersed pigment includes a pigment, and at least one organic group that includes at least one phosphorus-containing group. In an example, the at least one phosphorus-containing group has at least one P—O bond or P═O bond.

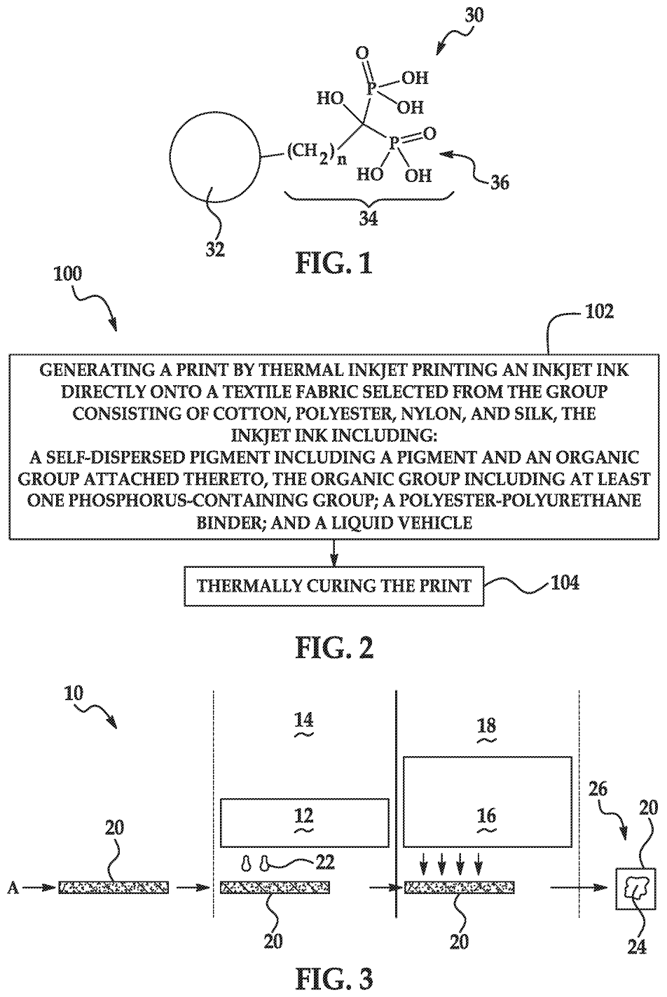

A schematic illustration of the self-dispersed pigment 30 is shown in FIG. 1. The pigment 32 is attached to the organic group 34, which includes two phosphorus-containing groups 36. It is to be understood that the organic group 34 shown in FIG. 1 is one example of the organic group, and that any of the organic groups 34 described herein may be used.

The pigment 32 may depend upon the color of the inkjet ink, and in an example may be a carbon, a phthalocyanine, a quinacridone, an azo compound, or any other type of organic pigment. Any carbon, phthalocyanine, quinacridone, azo, or any other type of organic pigment may be used as the pigment 32 as long as at least one organic molecule 34 is attached to the pigment 32 and the organic molecule 34 contains one or more phosphorus-containing groups 36. An example of a carbon pigment includes carbon black. Examples of phthalocyanine pigments include copper phthalocyanines, such as pigment blue 15, pigment blue 15:1, pigment blue 15:3, pigment blue 15:4, pigment blue 15:6, pigment green 7, pigment green 36, etc. Examples of quinacridone pigments include pigment violet 19, pigment red 202, and pigment red 122. Examples of azo pigments include pigment yellow 12, pigment yellow 13, pigment yellow 14, pigment yellow 17, pigment yellow 74, pigment yellow 155, pigment orange 34, pigment yellow 151, pigment red 150, pigment red 256, pigment red 269, pigment orange 34, etc. Other types of organic pigments that may be used for the pigment 32 include pigment red 149, pigment red 254, pigment orange 43, pigment orange 64, pigment orange 71, pigment orange 73, pigment blue 60, pigment violet 23, etc.

The organic group 34 include at least one phosphorus-containing group 36 having at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof.

By “partial ester thereof”, it is meant that the phosphorus-containing group 36 may be a partial phosphonic acid ester group having the formula —PO₃RH, or a salt thereof, wherein R is an aryl, alkaryl, aralkyl, or alkyl group.

By “salts thereof”, it is meant that the phosphorus-containing group 36 may be in a partially or fully ionized form having a cationic counterion.

In an example, the organic group 34 includes at least one phosphonic acid group, partial ester thereof, or salt thereof. In some examples, the organic group 34 includes at least two of these groups, such as at least two phosphonic acid groups, partial esters thereof, or salts thereof. When the organic group 34 includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group 34 includes at least two phosphonic acid groups, either or both of the phosphonic acid groups may be in either a partially or fully ionized form. In these examples, either or both may of the phosphonic acid groups have the formula —PO₃H₂, —PO₃H⁻ M⁺(monobasic salt), or —PO₃⁻² M⁺² (dibasic salt), wherein M⁺ is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group 34 may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof. The example shown in FIG. 1 is a geminal bisphosphonic acid group.

An example of a geminal bisphosphonic acid group may have the formula —CQ(PO₃H₂)₂, or may be partial esters thereof or salts thereof. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH (as shown in FIG. 1), or NH₂. Another example of a geminal bisphosphonic acid group may have the formula —(CH₂)ₙCQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the pigment, meaning there are no additional atoms or groups from the attached organic group 34 between the pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein R′, which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X—Sp—(CH₂)ₙCQ(PO₃H₂)₂, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X—Sp—(CH₂)ₙCQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group 34 may include at least one group having the formula —(CH₂)n-N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group 34 may include at least one group having the formula —X—(CH₂)ₙ—N—[(CH₂)ₘ(PO₃H₂)]₂, partial esters thereof, or salts thereof, wherein X, m, and n are as described above, and, in an example, X is an arylene group. Still further, the organic group 34 may include at least one group having the formula —X—Sp—(CH₂)ₙ—N—[(CH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group 34 may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group 34 may include a group having the formula —X—[CQ(PO₃H₂)₂]_{P}, partial esters thereof, or salts thereof. In this example, X and Q are as described above. In this formula, p is 1 to 4, e.g., 2.

In addition, the organic group 34 may include at least one vicinal bisphosphonic acid group, partial ester thereof, or salts thereof, meaning that these groups are adjacent to each other. Thus, the organic group 34 may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group 34 including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group 34 may be a group having the formula —C₆H₃—(PO₃H₂)₂, partial esters thereof, or salts thereof, wherein the acid, ester, or salt groups are in positions ortho to each other.

Without being bound to any theory, it is believed that the phosphorus-containing group(s) 36 of the organic group 34, which play a role in rendering the pigment 32 self-dispersing, also play a role in obtaining good print properties when the inkjet ink is printed on a variety of textiles, including, for example polyester, nylon and silk.

Examples of the self-dispersed pigments 30 are commercially available as dispersions. Suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)).

The self-dispersed pigment 30 is present in an amount ranging from about 1 wt % to about 6 wt % based on a total weight of the inkjet ink. In an example, the dispersed pigment 30 is present in an amount ranging from about 2 wt % to about 5 wt % based on a total weight of the inkjet ink. In another example, the self-dispersed pigment is present in an amount of about 3 wt % based on the total weight of the inkjet ink. In still another example, the self-dispersed pigment is present in an amount of about 5 wt % based on the total weight of the inkjet ink.

The inkjet ink also includes a polyester-polyurethane binder. In an example, the polyester-polyurethane binder is a sulfonated polyester-polyurethane binder. The sulfonated polyester-polyurethane binder can include diaminesulfonate groups. In an example, the polyester-polyurethane binder is a sulfonated polyester-polyurethane binder, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₈, or C₃ to C₆ alkyl. These polyester-polyurethane binders can be described as “alkyl” or “aliphatic” because these carbon chains are saturated and because they are devoid of aromatic moieties. An example of an anionic aliphatic polyester-polyurethane binder that can be used is IMPRANIL® DLN-SD (CAS #375390-41-3; Mw 45,000 Mw; Acid Number 5.2; Tg −47° C.; Melting Point 175-200° C.) from Covestro. Example components used to prepare the IMPRANIL® DLN-SD or other similar anionic aliphatic polyester-polyurethane binders can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyl diisocyanates (e.g., hexamethylene diisocyanate (HDI)); diamine sulfonic acids (e.g., 1-[(2-aminoethyl)amino]-ethanesulfonic acid); etc.

Alternatively, the sulfonated polyester-polyurethane binder can be aromatic (or include an aromatic moiety) and can include aliphatic chains. An example of an aromatic polyester-polyurethane binder that can be used is DISPERCOLL® U42 (CAS #157352-07-3). Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 1-[(2-aminoethyl)amino]-ethanesulfonic acid); etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types. Conversely, other types of polyurethanes (other than the polyester-type polyurethanes) do not tend to perform as well when jetting from thermal inkjet printheads and/or do not perform as well on fabric substrates, e.g., some jet acceptably but do not provide good washfastness, others provide good washfastness but are thermally jetted poorly, and others perform poorly in both categories. The pigmented inkjet inks disclosed herein, which include the polyester-polyurethane binder, can provide acceptable or better washfastness durability on a variety of substrates, making this a versatile ink composition for fabric printing, e.g., cotton, polyester, cotton/polyester blends, nylon, etc.

The polyester-polyurethane binders disclosed herein may have a weight average molecular weight (Mw) ranging from about 20,000 to about 300,000. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg/g KOH to about 50 mg/g KOH. As used herein, the term “acid number” refers to the mass of potassium hydroxide (KOH) in milligrams that is used to neutralize one gram of the sulfonated polyester-polyurethane binder.

To determine the acid number, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the Mütek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC).

As examples, the acid number of the sulfonated polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

In an example of the inkjet ink, the polyester-polyurethane binder has a weight average molecular weight ranging from about 20,000 to about 300,000 and an acid number ranging from about 1 mg KOH/g to about 50 mg KOH/g.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 250 nm. The particle size of any solids herein, including the average particle size of the dispersed polymer binder, can be determined using a NANOTRAC® Wave device, from Microtrac, e.g., NANOTRAC® Wave II or NANOTRAC® 150, etc, which measures particles size using dynamic light scattering. Average particle size can be determined using particle size distribution data generated by the NANOTRAC® Wave device.

In an example, the polyester-polyurethane binder can be present, in the inkjet ink, in an amount ranging from about 2 wt % to about 15 wt % based on the total weight of the inkjet ink. In another example, the polyester-polyurethane binder can be present, in the inkjet ink, in an amount ranging from about 2 wt % to about 10 wt % based on the total weight of the inkjet ink.

As set forth in the various examples herein, select amounts of the self-dispersed pigment 30 and select amounts of the polyester-polyurethane binder may be present in the inkjet ink. In an example, the self-dispersed pigment is present in an amount ranging from about 1 wt % to about 6 wt % based on a total weight of the inkjet ink, and the polyester-polyurethane binder is present in an amount ranging from about 2 wt % to about 10 wt % based on the total weight of the inkjet ink.

The inkjet ink also includes a liquid vehicle. As used herein, the term “liquid vehicle” may refer to the liquid fluid with which the self-dispersed pigment (or dispersion thereof) and the polyester-polyurethane binder are mixed to form the inkjet ink(s). A wide variety of liquid vehicles may be used with the inkjet ink(s) of the present disclosure. In an example, the liquid vehicle may include water and a co-solvent. In examples where the inkjet ink is a thermal inkjet ink, the liquid vehicle is an aqueous based vehicle including at least 70% by weight of water. In examples where the inkjet ink is a piezoelectric inkjet ink, the liquid vehicle is a solvent based vehicle including at least 50% by weight of the co-solvent.

In some examples, the liquid vehicle of the inkjet ink for textile printing includes water and co-solvent, and further comprises an additive(s) selecting from the group consisting of an anti-kogation agent, an anti-decel agent, a surfactant, a biocide, or combinations thereof. In any of the examples disclosed herein, the liquid vehicle may also include a pH adjuster. In an example, the liquid vehicle consists of the water and the co-solvent, and one or more of the following additives: the anti-kogation agent, the anti-decel agent, the surfactant, the biocide, and a pH adjuster. In still another example, the liquid vehicle consists of the anti-kogation agent, the anti-decel agent, the surfactant, the biocide, and water.

The liquid vehicle may include co-solvent(s). For a thermal inkjet formulation, the co-solvent(s) may be present in an amount ranging from about 2 wt % to about 20 wt % (based on the total weight of the inkjet ink). For a piezoelectric inkjet formulation, the co-solvent(s) may be present in an amount ranging from about 50 wt % to about 85 wt % (based on the total weight of the inkjet ink). In an example, the liquid vehicle includes glycerol as the co-solvent. Other examples of co-solvents include alcohols, amides, esters, ketones, lactones, and ethers. More specifically, the co-solvents may be aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Some specific examples of suitable organic co-solvents include 2-pyrrolidone, 2-ethyl-2-(hydroxymethyl)-1,3-propane diol (EPHD), glycerol, dimethyl sulfoxide, sulfolane, glycol ethers, alkyldiols such as 1,2-hexanediol, ethanol, isopropyl alcohol, butyl alcohol, and benzyl alcohol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

An anti-kogation agent may also be included in the vehicle. Kogation refers to the deposit of dried ink on a heating element of a thermal inkjet printhead. Anti-kogation agent(s) is/are included in thermal inkjet inks to assist in preventing the buildup of kogation. In some examples, the anti-kogation agent may improve the jettability of the inkjet ink. The anti-kogation agent may be present in the inkjet ink in an amount ranging from about 0.1 wt % to about 1.5 wt %, based on the total weight of the inkjet ink. In an example, the anti-kogation agent is present in the inkjet ink in an amount of about 0.5 wt %, based on the total weight of the inkjet ink.

Examples of suitable anti-kogation agents include oleth-3-phosphate (commercially available as CRODAFOS™ 03 A or CRODAFOS™ N-3A) or dextran 500k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

The liquid vehicle may include anti-decel agent(s). Decel refers to a decrease in drop velocity over time with continuous firing of a printhead. Anti-decel agent(s) is/are included to assist in preventing decel. In some examples, the anti-decel agent may improve the jettability of the inkjet ink. The anti-decel agent may be present in an amount ranging from about 0.2 wt % to about 5 wt % (based on the total weight of the inkjet ink). In an example, the anti-decel agent is present in the inkjet ink in an amount of about 1 wt %, based on the total weight of the inkjet ink.

An example of a suitable anti-decel agent is ethoxylated glycerin having the following formula:

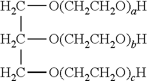

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The liquid vehicle of the inkjet ink may also include surfactant(s). In any of the examples disclosed herein, the surfactant may be present in an amount ranging from about 0.1 wt % to about 3 wt % (based on the total weight of the inkjet ink). In an example, the surfactant is present in the inkjet ink in an amount of about 0.3 wt %, based on the total weight of the inkjet ink.

The surfactant may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the liquid vehicle may include a silicone-free alkoxylated alcohol surfactant such as, for example, TEGO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); CAPSTONE®, which is a water-soluble, ethoxylated non-ionic fluorosurfactant from Chemours); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.).

The liquid vehicle may also include biocide(s). In an example, the total amount of biocide(s) in the inkjet ink ranges from about 0.02 wt % to about 0.05 wt % (based on the total weight of the inkjet ink). In another example, the total amount of biocide(s) in the thermal inkjet ink is about 0.044 wt % (based on the total weight of the inkjet ink). In some instances, the biocide may be present in the pigment dispersion that is mixed with the vehicle.

Examples of suitable biocides include the NUOSEPT® (Ashland Inc.), UCARCIDE™ or KORDEK™ (Dow Chemical Co.), PROXEL® (Arch Chemicals) series, ACTICIDE® B20 and ACTICIDE® M20 (Thor Chemicals), and combinations thereof.

The vehicle may also include a pH adjuster. A pH adjuster may be included in the inkjet ink to achieve a desired pH (e.g., a pH of about 8.5) and/or to counteract any slight pH drop that may occur over time. In an example, the total amount of pH adjuster(s) in the inkjet ink ranges from greater than 0 wt % to about 0.1 wt % (based on the total weight of the inkjet ink). In another example, the total amount of pH adjuster(s) in the inkjet ink composition is about 0.03 wt % (based on the total weight of the inkjet ink).

Examples of suitable pH adjusters include metal hydroxide bases, such as potassium hydroxide (KOH), sodium hydroxide (NaOH), etc. In an example, the metal hydroxide base may be added to the thermal inkjet ink in an aqueous solution. In another example, the metal hydroxide base may be added to the thermal inkjet ink in an aqueous solution including 5 wt % of the metal hydroxide base (e.g., a 5 wt % potassium hydroxide aqueous solution).

The balance of the inkjet ink is water. In an example, deionized water may be used. The water included in the inkjet ink may be: i) part of the pigment dispersion, ii) part of the vehicle, iii) added to a mixture of the pigment dispersion and the vehicle, or iv) a combination thereof. As mentioned above, the amount of water may vary, depending upon whether the ink is formulated for thermal or piezoelectric inkjet printing.

Textile Fabrics

In an example of printing method 100 (FIG. 2) and for use in the system 10 (FIG. 3), the textile fabric (shown as reference numeral 20 in FIG. 3) is selected from the group consisting of polyester, nylon (polyamides), silk, and cotton (including treated and untreated cotton substrates). The polyester may be a polyester blend. The polyester blend fabrics may be blends of polyester and other materials (e.g., cotton, linen, nylons, etc., as long as polyester is present in an amount of at least 50 wt % and is present at or near the surface of the fabric). In one example, the polyester blend includes from about 70 wt % to about 80 wt % of the polyester.

Examples of other suitable textile fabrics include natural fiber fabrics or synthetic fiber fabrics. Example natural fiber fabrics that can be used include treated or untreated natural fabric textile substrates, e.g., wool, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as polyvinyl chloride (PVC) fibers, PVC-free fibers made of polyester, polyamide, polyimide, polyacrylic, polypropylene, polyethylene, polyurethane, polystyrene, polyaramid, e.g., KEVLAR® (E. I. du Pont de Nemours Company), polytetrafluoroethylene, fiberglass, polytrimethylene, polycarbonate, polyethylene terephthalate, polyester terephthalate, polybutylene terephthalate, or combinations thereof.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the textile fabric or fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

Textile Printing Kit

The inkjet ink described herein may be part of a textile printing kit. In an example, the textile printing kit comprises a textile fabric selected from the group consisting of cotton, polyester, nylon and silk, and an inkjet ink to be printed on the textile fabric, the inkjet ink including a self-dispersed pigment including a pigment and an organic group attached thereto, the organic group including at least one phosphorus-containing group, a polyester-polyurethane binder, and a liquid vehicle. It is to be understood that any example of the inkjet ink may be used in the examples of the textile printing kit.

In another example of the textile printing kit, the self-dispersed pigment is present in an amount ranging from about 1 wt % to about 6 wt % based on a total weight of the inkjet ink, the polyester-polyurethane binder is present in an amount ranging from about 2 wt % to about 10 wt % based on the total weight of the inkjet ink; and the liquid vehicle includes water and a co-solvent, the co-solvent being present in an amount ranging from about 2 wt % to about 20 wt % based on the total weight of the inkjet ink.

In an example of the textile printing kit, the textile fabric is polyester.

In still another example, the inkjet ink of the textile printing kit includes the self-dispersed pigment, the polyester-polyurethane binder, the liquid vehicle, and at least one additive selected from the group consisting of an anti-kogation agent, an anti-decel agent, a surfactant, a biocide, or combinations thereof.

In yet a further example, the inkjet ink of the textile printing kit includes the self-dispersed pigment, the polyester-polyurethane binder, and the liquid vehicle, where the polyester-polyurethane binder is a sulfonated polyester-polyurethane binder having a weight average molecular weight ranging from about 20,000 to about 300,000 and an acid number ranging from about 1 mg KOH/g to about 50 mg KOH/g.

In some examples, the textile printing kit consists of the textile fabric and the inkjet ink with no other components. In other examples, the kit includes additional components, such as a thermal inkjet printer or a piezoelectric printer. The components of the kit may be maintained separately until used together in examples of the printing method disclosed herein.

Printing Method and System

FIG. 2 depicts an example of the printing method 100. As shown in FIG. 2, an example the printing method 100 comprises: generating a print by thermal inkjet printing an inkjet ink directly onto a textile fabric selected from the group consisting of cotton, polyester, nylon, and silk, the inkjet ink including a self-dispersed pigment including a pigment and an organic group attached thereto, the organic group including at least one phosphorus-containing group, a polyester-polyurethane binder and a liquid vehicle (reference numeral 102); and thermally curing the print (reference numeral 104).

It is to be understood that any example of the inkjet ink may be used in the examples of the method 100. In an example of the printing method 100, the self-dispersed pigment is present in an amount ranging from about 1 wt % to about 6 wt % based on a total weight of the inkjet ink, the polyester-polyurethane binder is present in an amount ranging from about 2 wt % to about 10 wt % based on the total weight of the inkjet ink, the liquid vehicle includes a co-solvent and a balance of water, and the inkjet ink further comprises an additive selected from the group consisting of an anti-kogation agent, and anti-decel agent, a surfactant, a biocide, or a combination thereof.

As shown in reference numeral 102 in FIG. 2, the method 100 includes generating a print by thermal inkjet printing the inkjet ink directly onto the textile fabric. In other examples of the method, the print may be generating using piezoelectric printing.

As shown in reference numeral 104 in FIG. 2, the method 100 includes thermally curing the print. In an example of the method 100, thermally curing the print involves heating the print to a temperature ranging from about 100° C. to about 180° C. for a time suitable to thermally cure the ink on the textile fabric (e.g., from about 30 seconds to 5 minutes). In an example, the print's thermal curing is achieved by heating the print to a temperature of 150° C. for about 3 minutes.

Referring now to FIG. 3, a schematic diagram of a printing system 10 including a thermal inkjet printer 12 in a printing zone 14 of the printing system 10 and a dryer 16 positioned in a fixation zone 18 of the printing system 10.

In one example, a textile fabric/substrate 20 may be transported through the printing system 10 along the path shown by arrow A such that the textile substrate 20 is first fed to the printing zone 14 where an example of a pigmented inkjet ink 22 is inkjet printed directly onto the textile substrate 20 by the inkjet printer 12 (for example, from a piezo- or thermal-inkjet printhead) to form an ink layer on the textile substrate 20. The ink layer disposed on the textile substrate 20 may be heated in the printing zone 34 (for example, the air temperature in the printing zone 14 may range from about 10° C. to about 90° C.) such that water may be at least partially evaporated from the ink layer. As an example, at least partial evaporation means that at least 50% of the water is removed. It may be desirable for enough water to be removed from an area so that color in the area is not transferred to an adjacent portion/facing surface of the textile substrate 20 during/after rolling that comes in contact with the area.

The textile substrate 20 (having the ink layer printed thereon) may then be transported to the fixation zone 18 where the ink layer is heated to fix the pigment. The heat is sufficient to bind the pigment onto the textile substrate 20. The heat to initiate fixation may range from about 100° C. to about 180° C. The fixation of the ink forms the printed article 26 including the image 24 formed on the textile substrate 20.

To further illustrate the present disclosure, examples are given herein. It is to be understood these examples are provided for illustrative purposes and are not to be construed as limiting the scope of the present disclosure.

### EXAMPLES

### Example 1

Four examples of the inkjet ink disclosed herein were prepared, and nine comparative examples of the inkjet ink were prepared. Each example inkjet ink and each comparative example inkjet ink had the same general formulation except for the type of pigment dispersion. The type of the pigment dispersion in each example inkjet ink and each comparative example inkjet ink is shown below in Table 2. The general formulation of the example inkjet inks and the comparative inkjet inks, except for the type of pigment dispersion, is shown in Table 1, with the wt % of each component that was used. The weight percentage of the pigment dispersion represents the total pigment solids present in the final inkjet ink formulations. In other words, the amount of the pigment dispersion added to the example or comparative inkjet inks was enough to achieve a pigment solids level equal to the given weight percent. Similarly, the weight percentage of the binder represents the total binder solids present in the final inkjet ink formulations. Additionally, a 5 wt % potassium hydroxide aqueous solution was added to each of the example inkjet inks and each of the comparative inkjet inks until a pH of about 8.5 was achieved.

TABLE 1

| | | Amount |
|---|---|---|
| Ingredient | Specific Component | (wt %) |
| Pigment dispersion | Example pigment dispersion or | 2.5 |
| | Comparative example pigment | |
| | dispersion | |
| Binder | IMPRANIL ® DLN-SD | 6 |
| Co-solvent | Glycerol | 8 |
| Anti-decel agent | LIPONIC ® EG-1 | 1 |
| Anti-kogation agent | CRODAFOS ® N-3A | 0.5 |
| Surfactant | SURFYNOL ® 440 | 0.3 |
| Biocide | ACTICIDE ® B20* | 0.22** |
| Water | | Balance |

*20% active;
**0.22% as is or 0.044% active

The type of the pigment dispersion in each example inkjet ink and each comparative inkjet ink is shown in Table 2. The pigment color and the dispersant type for each example inkjet ink and each comparative inkjet ink are also shown in Table 2. As shown in Table 2, each example inkjet ink included a self-dispersed pigment with at least one phosphonic group. As also shown in Table 2, each comparative 1 inkjet ink included a carboxylic polymer dispersant; each comparative 2 inkjet ink included a self-dispersed pigment with at least one carboxylic group; and each comparative 3 inkjet ink included a self-dispersed pigment with at least one sulfonic group.

TABLE 2

| | Pigment | Pigment | Dispersant |
|---|---|---|---|
| Inkjet Ink ID | Color | Dispersion | Type |
| Example black | Black | CAB-O-JET ® 400 | At least one |
| Example cyan | Cyan | CAB-O-JET ® 450C | phosphonic |
| Example magenta | Magenta | CAB-O-JET ® 465M | group attached |
| Example yellow | Yellow | CAB-O-JET ® 470Y | to pigment |
| Comparative 1 | Black | Dispersion K | Carboxylic |
| black | | | polymer |
| Comparative 1 | Cyan | Dispersion C | dispersant |
| cyan | | | |
| Comparative 1 | Magenta | Dispersion M | |
| magenta | | | |
| Comparative 1 | Yellow | Dispersion Y | |
| yellow | | | |
| Comparative 2 | Black | CAB-O-JET ® 300 | At least one |
| black 1 | | | carboxylic |
| Comparative 2 | Black | CAB-O-JET ® 325K | group attached |
| black 2 | | | to pigment |
| Comparative 3 black | Black | CAB-O-JET ® 200 | At least one |
| Comparative 3 cyan | Cyan | CAB-O-JET ® 250C | sulfonic group |
| Comparative 3 | Magenta | CAB-O-JET ® 265M | attached to |
| magenta | | | pigment |

Each example inkjet ink and each comparative inkjet ink was used to generate several prints by thermal inkjet. The amount of ink printed was 20 grams per square meter (gsm). The prints were generated on polyester, nylon, silk, and gray cotton. No pre-treatment was performed on any of the fabrics before generating the prints. Each print was cured at 150° C. for 3 minutes.

The initial optical density (initial OD) of each print was measured. Then, each print was washed 5 times in a Kenmore 90 Series Washer (Model 110.289 227 91) with warm water (at about 40° C.) and detergent. Each print was allowed to air dry between each wash. Then, the optical density (OD after 5 washes) of each print was measured, and the percent change in optical density (%Δ OD) was calculated for each print.

OD—Polyester Results

The initial optical density (initial OD), the optical density after 5 washes (OD after 5 washes), and the percent change in optical density (%Δ in OD) of each print generated on polyester are shown in Table 3. In Table 3, each print is identified by the inkjet ink used to generate the print.

TABLE 3
(Polyester)

| Inkjet ink used to | | OD after | |
|---|---|---|---|
| generate the print | Initial OD | 5 washes | % Δ in OD |
| Example black | 1.299 | 1.229 | −5.4 |
| Comparative 1 black | 1.140 | 1.001 | −12.2 |
| Comparative 2 black 1 | 1.153 | 1.093 | −5.2 |
| Comparative 2 black 2 | 1.061 | 1.021 | −3.8 |
| Comparative 3 black | 1.062 | 1.034 | −2.6 |
| Example cyan | 1.247 | 1.178 | −5.5 |
| Comparative 1 cyan | 1.105 | 0.932 | −15.7 |
| Comparative 3 cyan | 1.135 | 1.102 | −3.0 |
| Example magenta | 1.178 | 1.073 | −8.9 |
| Comparative 1 magenta | 1.020 | 0.942 | −7.6 |
| Comparative 3 magenta | 1.039 | 0.922 | −11.3 |
| Example yellow | 1.363 | 1.313 | −3.7 |
| Comparative 1 yellow | 1.183 | 1.112 | −6.0 |

As shown in Table 3, the change in optical density was less than 10% for each of the prints generated by the example inkjet inks. Table 3 also shows that each print generated by one of the example inkjet inks had an initial OD greater than the initial OD of each print generated by a comparative inkjet ink of the same color. In other words, the print generated by the example black inkjet ink had an initial OD greater than the initial OD of each print generated by the black, comparative inkjet inks; the print generated by the example cyan inkjet ink had an initial OD greater than the initial OD of each print generated by the cyan, comparative inkjet inks; the print generated by the example magenta inkjet ink had an initial OD greater than the initial OD of each print generated by the magenta, comparative inkjet inks; and the print generated by the example yellow inkjet ink had an initial OD greater than the initial OD of the print generated by the yellow, comparative inkjet ink. As also shown in Table 3, each print generated by one of the example inkjet inks had an OD after 5 washes greater than the OD after 5 washes of each print generated by a comparative inkjet ink of the same color. These results indicate that the prints generated on polyester with an inkjet ink including a self-dispersed pigment with at least one phosphonic group have higher optical density than prints generated on polyester with i) inkjet ink including pigment dispersed with a carboxylic polymer dispersant, ii) inkjet ink including a self-dispersed pigment with at least one carboxylic group, or iii) inkjet ink including a self-dispersed pigment with at least one sulfonic group.

Additionally, comparative prints were generated by thermal inkjet on polyester with each of several additional comparative inkjet inks (i.e., comparative 4 black, comparative 4 cyan, comparative 4 magenta 1, comparative 4 magenta 2, comparative 4 magenta 3, comparative 4 yellow 1, comparative 4 yellow 2, and comparative 4 yellow 3). The amount of ink printed was 20 grams per square meter (gsm). No pre-treatment was performed on the polyester before generating the prints. Each print was cured at 150° C. for 3 minutes.

Comparative 4 black inkjet ink had the formulation of the comparative 1 black inkjet ink except that the comparative 4 black inkjet ink included 3 wt % of the pigment dispersion (solids). Comparative 4 cyan inkjet ink had the formulation of the comparative 1 cyan inkjet ink except that the comparative 4 cyan inkjet ink included 3 wt % of the pigment dispersion (solids). Each of comparative 4 magenta 1 inkjet ink, comparative 4 magenta 2 inkjet ink, and comparative 4 magenta 3 inkjet ink had the formulation of the comparative 1 magenta inkjet ink except that the comparative 4 magenta 1 inkjet ink included 3.5 wt % of the pigment dispersion (solids), the comparative 4 magenta 2 inkjet ink included 4 wt % of the pigment dispersion (solids), and the comparative 4 magenta 3 inkjet ink included 4.25 wt % of the pigment dispersion (solids). Each of comparative 4 yellow 1 inkjet ink, comparative 4 yellow 2 inkjet ink, and comparative 4 yellow 3 inkjet ink had the formulation of the comparative 1 yellow inkjet ink except that the comparative 4 yellow 1 inkjet ink included 3.5 wt % of the pigment dispersion (solids), the comparative 4 yellow 2 inkjet ink included 4 wt % of the pigment dispersion (solids), and the comparative 4 yellow 3 inkjet ink included 4.25 wt % of the pigment dispersion (solids).

The initial OD of each print generated by the comparative 4 inkjet inks was measured, although the results are not reproduced here. Each print generated on polyester by one of the example inkjet inks had an initial OD (see Table 3) greater than the initial OD of each print generated by the comparative 4 inkjet ink(s) of the same color. These results indicate that the prints generated on polyester with an inkjet ink including a self-dispersed pigment with at least one phosphonic group have higher optical density than prints generated on polyester with inkjet inks including pigment dispersed with a carboxylic polymer dispersant, even when the inkjet ink including pigment dispersed with a carboxylic polymer dispersant has a higher pigment loading.

OD—Nylon Results

The initial optical density (initial OD), the optical density after 5 washes (OD after 5 washes), and the percent change in optical density (%Δ in OD) of each print generated on nylon are shown in Table 4. In Table 4, each print is identified by the inkjet ink used to generate the print.

TABLE 4
(Nylon)

| Inkjet ink used to | | OD after | |
|---|---|---|---|
| generate the print | Initial OD | 5 washes | % Δ in OD |
| Example black | 1.224 | 1.112 | −9.2 |
| Comparative 1 black | 1.181 | 1.069 | −9.4 |
| Comparative 2 black 1 | 1.167 | 1.074 | −8.0 |
| Comparative 2 black 2 | 1.104 | 1.060 | −4.0 |
| Comparative 3 black | 1.066 | 1.013 | −5.0 |
| Example cyan | 1.233 | 1.132 | −8.2 |
| Comparative 1 cyan | 1.141 | 1.058 | −7.2 |
| Comparative 3 cyan | 1.170 | 1.114 | −4.8 |
| Example magenta | 1.147 | 1.076 | −6.1 |
| Comparative 1 magenta | 1.089 | 1.013 | −6.9 |
| Comparative 3 magenta | 1.051 | 0.975 | −7.2 |
| Example yellow | 1.260 | 1.181 | −6.3 |
| Comparative 1 yellow | 1.131 | 1.053 | −6.9 |

As shown in Table 4, the change in optical density was less than 10% for each of the prints generated by the example inkjet inks. Table 4 also shows that each print generated by one of the example inkjet inks had an initial OD greater than the initial OD of each print generated by a comparative inkjet ink of the same color. As also shown in Table 4, each print generated by one of the example inkjet inks had an OD after 5 washes greater than the OD after 5 washes of each print generated by a comparative inkjet ink of the same color. These results indicate that the prints generated on nylon with an inkjet ink including a self-dispersed pigment with at least one phosphonic group have higher optical density than prints generated on nylon with i) inkjet ink including pigment dispersed with a carboxylic polymer dispersant, ii) inkjet ink including a self-dispersed pigment with at least one carboxylic group, or iii) inkjet ink including a self-dispersed pigment with at least one sulfonic group.

OD—Silk Results

The initial optical density (initial OD), the optical density after 5 washes (OD after 5 washes), and the percent change in optical density (%Δ in OD) of each print generated on silk are shown in Table 5. In Table 5, each print is identified by the inkjet ink used to generate the print.

TABLE 5
(Silk)

| Inkjet ink used to | | OD after | |
|---|---|---|---|
| generate the print | Initial OD | 5 washes | % Δ in OD |
| Example black | 1.383 | 1.122 | −18.9 |
| Comparative 1 black | 1.224 | 0.988 | −19.3 |
| Example cyan | 1.252 | 1.001 | −20.0 |
| Comparative 1 cyan | 1.156 | 0.937 | −19.0 |
| Example magenta | 1.249 | 0.985 | −21.1 |
| Comparative 1 magenta | 1.150 | 0.919 | −20.1 |
| Example yellow | 1.312 | 1.046 | −20.3 |
| Comparative 1 yellow | 1.190 | 0.957 | −19.6 |

As shown in Table 5, each print generated by one of the example inkjet inks had an initial OD greater than the initial OD of each print generated by a comparative inkjet ink of the same color. As also shown in Table 5, each print generated by one of the example inkjet inks had an OD after 5 washes greater than the OD after 5 washes of each print generated by a comparative inkjet ink of the same color. These results indicate that the prints generated on silk with an inkjet ink including a self-dispersed pigment with at least one phosphonic group have higher optical density than prints generated on silk with an inkjet ink including pigment dispersed with a carboxylic polymer dispersant.

OD—Gray Cotton

The initial optical density (initial OD), the optical density after 5 washes (OD after 5 washes), and the percent change in optical density (%Δ in OD) of each print generated on gray cotton are shown in Table 6. In Table 6, each print is identified by the inkjet ink used to generate the print.

TABLE 6
(Gray Cotton)

| Inkjet ink used to | | OD after | |
|---|---|---|---|
| generate the print | Initial OD | 5 washes | % Δ in OD |
| Example black | 1.081 | 0.945 | −12.5 |
| Comparative 1 black | 1.087 | 0.976 | −10.3 |
| Comparative 2 black 1 | 1.124 | 1.027 | −8.6 |
| Comparative 2 black 2 | 1.092 | 0.991 | −9.3 |
| Comparative 3 black | 1.047 | 0.950 | −9.3 |
| Example cyan | 1.040 | 0.943 | −9.3 |
| Comparative 1 cyan | 1.079 | 0.966 | −10.5 |
| Comparative 3 cyan | 1.213 | 1.029 | −15.2 |
| Example magenta | 0.967 | 0.883 | −8.6 |
| Comparative 1 magenta | 0.942 | 0.863 | −8.4 |
| Comparative 3 magenta | 0.973 | 0.889 | −8.6 |
| Example yellow | 1.043 | 0.914 | −12.4 |
| Comparative 1 yellow | 0.939 | 0.855 | −9.0 |

As shown in Table 6, each print generated by one of the example inkjet inks had an initial OD comparable to the initial OD of each print generated by a comparative inkjet ink of the same color. As also shown in Table 6, each print generated by one of the example inkjet inks had an OD after 5 washes comparable to the OD after 5 washes of each print generated by a comparative inkjet ink of the same color. These results indicate that the prints generated on gray cotton with an inkjet ink including a self-dispersed pigment with at least one phosphonic group have comparable optical density to prints generated on gray cotton with i) inkjet ink including pigment dispersed with a carboxylic polymer dispersant, ii) inkjet ink including a self-dispersed pigment with at least one carboxylic group, or iii) inkjet ink including a self-dispersed pigment with at least one sulfonic group.

Each print was also tested for washfastness. The L*a*b* values of a color (e.g., cyan, magenta, yellow, black, red, green, blue, white) before and after the 5 washes were measured. L* is lightness, a* is the color channel for color opponents green-red, and b* is the color channel for color opponents blue-yellow. The color change was then calculated using both the CIEDE1976 color-difference formula and the CIEDE2000 color-difference formula.

The CIEDE1976 color-difference formula is based on the CIELAB color space. Given a pair of color values in CIELAB space L*₁,a*ᵢ,b*ᵢ and L*₂,a*₂,b*₂, the CIEDE1976 color difference between them is as follows:

ΔE₇₆=\sqrt{[(L*₂−L*₁)²+(a*₂−a*₁)²+(b*₂−b*₁)²]}

It is noted that ΔE₇₆ is the commonly accepted notation for CIEDE1976.

The CIEDE2000 color-difference formula is based on the CIELAB color space. Given a pair of color values in CIELAB space L*₁,a*₁,b*₁ and L*₂,a*₂,b*₂, the CIEDE2000 color difference between them is as follows:

ΔE₀₀(L*₁a*₁,b*₁;L*₂,a*₂,b*₂)=ΔE₀₀¹²=ΔE₀₀ (1)

It is noted that ΔE₀₀ is the commonly accepted notation for CIEDE2000.

Given two CIELAB color values {L*ᵢ,a*ᵢ,b*ᵢ}ᵢ₌₁² and parametric weighting factors k_{L}, k_{C}, k_{H}, the process of computation of the color difference is summarized in the following equations, grouped as three main parts.

1. Calculate C′ᵢ,h′ᵢ:

$$\begin{matrix}{C}_{i , ab}^{*} = \sqrt{( {( {a}_{i}^{*} )}^{2} + {( {b}_{i}^{*} )}^{2} )} , i = 1 , 2 & ( 2 ) \\ {\overline{C}}_{ab}^{*} = \frac{{C}_{1 , ab}^{*} + {C}_{2 , ab}^{*}}{2} & ( 3 ) \\ G = 0.5 ( 1 - \sqrt{( \frac{{\overline{C}}_{ab}^{* 7}}{{\overline{C}}_{ab}^{* 7} + {25}^{7}} )} ) & ( 4 ) \\ {a}_{i}^{′} = ( 1 + G ) {a}_{i}^{*} , i = 1 , 2 & ( 5 ) \\ {C}_{i}^{′} = \sqrt{( {( {a}_{i}^{*} )}^{2} + {( {b}_{i}^{*} )}^{2} )} , i = 1 , 2 & ( 6 ) \\ {h}_{i}^{′} = \{ \begin{matrix}0 & {b}_{i}^{*} = {a}_{i}^{′} = 0 \\ {tan}^{- 1} ( {b}_{i}^{*} , {a}_{i}^{′} ) & otherwise\end{matrix} , i = 1 , 2 & ( 7 )\end{matrix}$$

2. Calculate ΔL′, ΔC′, ΔH′:

$$\begin{matrix}Δ {L}^{′} = {L}_{2}^{*} - {L}_{1}^{*} & ( 8 ) \\ Δ {C}^{′} = {C}_{2}^{*} - {C}_{1}^{*} & ( 9 ) \\ Δ {h}^{′} = \{ \begin{matrix}0 & {C}_{1}^{′} {C}_{2}^{′} = 0 \\ {h}_{2}^{′} - {h}_{1}^{′} & {C}_{1}^{′} {C}_{2}^{′} \neq 0 ; \vert {h}_{2}^{′} - {h}_{1}^{′} \vert \leq 180 ° \\ ( {h}_{2}^{′} - {h}_{1}^{′} ) - 360 & {C}_{1}^{′} {C}_{2}^{′} \neq 0 ; ( {h}_{2}^{′} - {h}_{1}^{′} ) > 180 ° \\ ( {h}_{2}^{′} - {h}_{1}^{′} ) + 360 & {C}_{1}^{′} {C}_{2}^{′} \neq 0 ; ( {h}_{2}^{′} - {h}_{1}^{′} ) < - 180 °\end{matrix} & ( 10 ) \\ Δ {H}^{′} = 2 \sqrt{{C}_{1}^{′} {C}_{2}^{′}} sin ( \frac{Δ {h}^{′}}{2} ) & ( 11 )\end{matrix}$$

3. Calculate CIEDE2000 color-difference ΔE₀₀:

$$\begin{matrix}{\overline{L}}^{′} = ( {L}_{1}^{*} + {L}_{2}^{*} ) \text{/} 2 & ( 12 ) \\ {\overline{C}}^{′} = ( {C}_{1}^{′} + {C}_{2}^{′} ) \text{/} 2 & ( 13 ) \\ {\overline{h}}^{′} = \{ \begin{matrix}\frac{{h}_{1}^{′} + {h}_{2}^{′}}{2} & \vert {h}_{1}^{′} - {h}_{2}^{′} \vert \leq 180 ° ; {C}_{1}^{′} {C}_{2}^{′} \neq 0 \\ \frac{{h}_{1}^{′} + {h}_{2}^{′} + 360 °}{2} & \vert {h}_{1}^{′} - {h}_{2}^{′} \vert > 180 ° ; ( {h}_{1}^{′} + {h}_{2}^{′} ) < 360 ° ; {C}_{1}^{′} {C}_{2}^{′} \neq 0 \\ \frac{{h}_{1}^{′} + {h}_{2}^{′} - 360 °}{2} & \vert {h}_{1}^{′} - {h}_{2}^{′} \vert > 180 ° ; ( {h}_{1}^{′} + {h}_{2}^{′} ) \geq 360 ° ; {C}_{1}^{′} {C}_{2}^{′} \neq 0 \\ ( {h}_{1}^{′} + {h}_{2}^{′} ) & {C}_{1}^{′} {C}_{2}^{′} = 0\end{matrix} & ( 14 ) \\ T = 1 - 0.17 cos ( {\overline{h}}^{′} - 30 ° ) + 0.24 cos ( 2 {\overline{h}}^{′} ) + 0.32 cos ( 3 {\overline{h}}^{′} + 6 ° ) - 0.20 cos ( 4 {\overline{h}}^{′} - 63 ° ) & ( 15 ) \\ Δθ = 30 exp \{ - {[ \frac{{\overline{h}}^{′} - 275 °}{25} ]}^{2} \} & ( 16 ) \\ {R}_{c} = 2 \sqrt{( \frac{{\overline{C}}^{′7}}{{\overline{C}}^{′7} + {25}^{7}} )} & ( 17 ) \\ {S}_{L} = 1 + \frac{0.015 {( {\overline{L}}^{′} - 50 )}^{2}}{\sqrt{( 20 + {( {\overline{L}}^{′} - 50 )}^{2} )}} & ( 18 ) \\ {S}_{C} = 1 + 0.045 {\overline{C}}^{′} & ( 19 ) \\ {S}_{H} = 1 + 0.015 {\overline{C}}^{′} T & ( 20 ) \\ {R}_{T} = - sin ( 2 Δθ ) {R}_{C} & ( 21 ) \\ Δ {E}_{00}^{12} = Δ {E}_{00} ( {L}_{1}^{*} , {a}_{1}^{*} , {b}_{1}^{*} ; {L}_{2}^{*} ; {L}_{2}^{*} , {a}_{2}^{*} , {b}_{2}^{*} ) = \sqrt{( {( \frac{Δ {L}^{′}}{{k}_{L} {S}_{L}} )}^{2} + {( \frac{Δ {C}^{′}}{{k}_{C} {S}_{C}} )}^{2} + {( \frac{Δ {H}^{′}}{{k}_{H} {S}_{H}} )}^{2} + {R}_{T} ( \frac{Δ {C}^{′}}{{k}_{C} {S}_{C}} ) ( \frac{Δ {H}^{′}}{{k}_{H} {S}_{H}} ) )} & ( 22 )\end{matrix}$$

Washfastness—Polyester Results

The results of the ΔE₇₆ calculations and the ΔE₀₀ calculations for each print generated on polyester are shown in Table 7. In Table 7, each print is identified by the inkjet ink used to generate the print.

TABLE 7
(Polyester)

| Inkjet ink used to | | |
|---|---|---|
| generate the print | ΔE₇₆ | ΔE₀₀ |
| Example black | 2.14 | 1.62 |
| Comparative 1 black | 5.88 | 4.86 |
| Comparative 2 black 1 | 2.05 | 1.65 |
| Comparative 2 black 2 | 1.50 | 1.25 |
| Comparative 3 black | 1.87 | 1.56 |
| Example cyan | 2.10 | 1.41 |
| Comparative 1 cyan | 6.36 | 4.52 |
| Comparative 3 cyan | 0.90 | 0.63 |
| Example magenta | 4.34 | 2.02 |
| Comparative 1 magenta | 4.60 | 2.38 |
| Comparative 3 magenta | 4.85 | 2.57 |
| Example yellow | 2.91 | 0.68 |
| Comparative 1 yellow | 3.85 | 0.87 |

As shown in Table 7, each print generated by one of the example inkjet inks had a ΔE₇₆ value less than the ΔE₇₆ value of the print generated by the comparative 1 inkjet ink of the same color. In other words, the print generated by the example black inkjet ink had a ΔE₇₆ value less than the ΔE₇₆ value of the print generated by the comparative 1 black inkjet ink; the print generated by the example cyan inkjet ink had a ΔE₇₆ value less than the ΔE₇₆ value of the print generated by the comparative 1 cyan inkjet ink; the print generated by the example magenta inkjet ink had a ΔE₇₆ value less than the ΔE₇₆ value of the print generated by the comparative 1 magenta inkjet ink; and the print generated by the example yellow inkjet ink had a ΔE₇₆ value less than the ΔE₇₆ value of the print generated by the comparative 1 yellow inkjet ink. As also shown in Table 7, each print generated by one of the example inkjet inks had a ΔE₀₀ value less than the ΔE₀₀ value of the print generated by the comparative 1 inkjet ink of the same color. These results indicate that the prints generated on polyester with an inkjet ink including a self-dispersed pigment with at least one phosphonic group have better washfastness than prints generated on polyester with an inkjet ink including pigment dispersed with a carboxylic polymer dispersant. Table 7 also shows that the ΔE₇₆ value and the ΔE₀₀ value of each print generated by one of the example inkjet inks was comparable to, respectively, the ΔE₇₆ value and the ΔE₀₀ value of each print generated by the comparative 2 inkjet ink of the same color (if applicable) and the comparative 3 inkjet ink of the same color (if applicable). These results also indicate that the prints generated on polyester with an inkjet ink including a self-dispersed pigment with at least one phosphonic group attached thereto have comparable washfastness to prints generated on polyester with inkjet ink including a self-dispersed pigment with at least one carboxylic group attached thereto, or inkjet ink including a self-dispersed pigment with at least one sulfonic group attached thereto.

Washfastness—Nylon Results

The results of the ΔE₇₆ calculations and the ΔE₀₀ calculations for each print generated on nylon are shown in Table 8. In Table 8, each print is identified by the inkjet ink used to generate the print.

TABLE 8
(Nylon)

| Inkjet ink used to | | |
|---|---|---|
| generate the print | ΔE₇₆ | ΔE₀₀ |
| Example black | 3.28 | 2.57 |
| Comparative 1 black | 4.64 | 3.73 |
| Comparative 2 black 1 | 1.99 | 1.61 |
| Comparative 2 black 2 | 2.99 | 2.47 |
| Comparative 3 black | 2.98 | 2.51 |
| Example cyan | 4.58 | 3.87 |
| Comparative 1 cyan | 3.82 | 3.13 |
| Comparative 3 cyan | 3.80 | 3.29 |
| Example magenta | 3.46 | 1.91 |
| Comparative 1 magenta | 3.33 | 1.91 |
| Comparative 3 magenta | 3.16 | 1.86 |
| Example yellow | 3.90 | 0.87 |
| Comparative 1 yellow | 4.18 | 0.92 |

As shown in Table 8, each print generated by one of the example inkjet inks had a ΔE₇₆ value less than or comparable to the ΔE₇₆ value of the print generated by the comparative 1 inkjet ink of the same color. As also shown in Table 8, each print generated by one of the example inkjet inks had a ΔE₀₀ value less than or comparable to the ΔE₀₀ value of the print generated by the comparative 1 inkjet ink of the same color. These results indicate that the prints generated on nylon with an inkjet ink including a self-dispersed pigment with at least one phosphonic group have washfastness better than or comparable to prints generated on nylon with inkjet ink including pigment dispersed with a carboxylic polymer dispersant. Table 8 also shows that the ΔE₇₆ value and the ΔE₀₀ value of each print generated by one of the example inkjet inks was comparable to, respectively, the ΔE₇₆ value and the ΔE₀₀ value of each print generated by the comparative 2 inkjet ink of the same color (if applicable) and the comparative 3 inkjet ink of the same color (if applicable).

Washfastness—Silk Results

The results of the ΔE₇₆ calculations and the ΔE₀₀ calculations for each print generated on silk are shown in Table 9. In Table 9, each print is identified by the inkjet ink used to generate the print.

TABLE 9
(Silk)

| Inkjet ink used to | | |
|---|---|---|
| generate the print | ΔE₇₆ | ΔE₀₀ |
| Example black | 9.1 | 7.0 |
| Comparative 1 black | 9.16 | 7.45 |
| Example cyan | 9.9 | 6.4 |
| Comparative 1 cyan | 7.94 | 5.38 |
| Example magenta | 10.7 | 5.7 |
| Comparative 1 magenta | 10.30 | 5.57 |
| Example yellow | 13.1 | 2.7 |
| Comparative 1 yellow | 11.25 | 2.40 |

As shown in Table 9, each print generated by one of the example inkjet inks had a ΔE₇₆ value less than or comparable to the ΔE₇₆ value of the print generated by the comparative 1 inkjet ink of the same color. As also shown in Table 9, each print generated by one of the example inkjet inks had a ΔE₀₀ value less than or comparable to the ΔE₀₀ value of the print generated by the comparative 1 inkjet ink of the same color. These results indicate that the prints generated on silk with an inkjet ink including a self-dispersed pigment with at least one phosphonic group have washfastness comparable to prints generated on silk with inkjet ink including pigment dispersed with a carboxylic polymer dispersant.

Washfastness—Gray Cotton Results

The results of the ΔE₇₆ calculations and the ΔE₀₀ calculations for each print generated on gray cotton are shown in Table 10. In Table 10, each print is identified by the inkjet ink used to generate the print.

TABLE 10
(Gray Cotton)

| Inkjet ink used to | | |
|---|---|---|
| generate the print | ΔE₇₆ | ΔE₀₀ |
| Example black | 5.28 | 4.55 |
| Comparative 1 black | 5.18 | 4.41 |
| Comparative 2 black 1 | 4.26 | 3.57 |
| Comparative 2 black 2 | 4.66 | 3.96 |
| Comparative 3 black | 4.21 | 3.64 |
| Example cyan | 4.03 | 2.34 |
| Comparative 1 cyan | 4.24 | 2.68 |
| Comparative 3 cyan | 5.24 | 3.40 |
| Example magenta | 4.68 | 2.10 |
| Comparative 1 magenta | 4.99 | 2.18 |
| Comparative 3 magenta | 4.85 | 2.13 |
| Example yellow | 7.28 | 1.62 |
| Comparative 1 yellow | 5.19 | 1.19 |

As shown in Table 10, each print generated by one of the example inkjet inks had a ΔE₇₆ value less than or comparable to the ΔE₇₆ value of the print generated by the comparative 1 inkjet ink of the same color. As also shown in Table 10, each print generated by one of the example inkjet inks had a ΔE₀₀ value comparable to the ΔE₀₀ value of the print generated by the comparative 1 inkjet ink of the same color. These results indicate that the prints generated on gray cotton with an inkjet ink including a self-dispersed pigment with at least one phosphonic group attached thereto have washfastness comparable to prints generated on gray cotton with inkjet ink including pigment dispersed with a carboxylic polymer dispersant. Table 10 also shows that the ΔE₇₆ value and the ΔE₀₀ value of each print generated by one of the example inkjet inks was comparable to, respectively, the ΔE₇₆ value and the ΔE₀₀ value of each print generated by the comparative 2 inkjet ink of the same color (if applicable) and the comparative 3 inkjet ink of the same color (if applicable).

### Example 2

Each example inkjet ink (from Example 1) was also tested for stability. Each example inkjet ink was stored in an accelerated storage (AS) environment at a temperature of 60° C. for one week. The particle size for each example inkjet ink was measured before and after the ink formulations were stored in the AS environment. The particle size for each example inkjet ink was measured in terms of the volume-weighted mean diameter (Mv) using dynamic light scattering with a NANOTRAC® WAVE™ particle size analyzer (available from MICROTRAC™—NIKKISO GROUP™). Then the percent change in particle size was calculated for each example inkjet ink. The particle size for each example inkjet ink before and after one week in the AS environment and the results of the particle size change calculations are shown in Table 11.

TABLE 11

| | | Particle size | Particle size |
|---|---|---|---|
| | Particle size | after | change after |
| | before AS | 1 wk AS | 1 wk AS |
| Inkjet ink | (Mv, μm) | (Mv, μm) | (Mv, %) |
| Example black | 0.252 | 0.174 | −30.9 |
| Example cyan | 0.101 | 0.098 | −2.8 |
| Example magenta | 0.124 | 0.130 | 4.6 |
| Example yellow | 0.188 | 0.163 | −13.4 |

Additionally, each example inkjet ink was put through a T-cycle. During the T-cycle, each example inkjet ink was heated to and maintained at a high temperature of 70° C. for 4 hours, and then each example inkjet ink was cooled to and maintained at a low temperature of −40° C. for 4 hours. This process was repeated for each example inkjet ink for 5 cycles. For each example inkjet ink, the particle size (in terms of Mv and D95) was measured before and after the T-cycle, and the percent change in particle size was calculated. The particle size for each example inkjet ink before and after the T-cycle and the results of the particle size change calculations are shown below in Table 12.

TABLE 12

| | Particle size | Particle size | Particle size |
|---|---|---|---|
| | before | after | % change |
| | T-cycle | T-cycle | after T-cycle |
| Inkjet ink | (Mv, μm) | (Mv, μm) | (Mv, %) |
| Example black | 0.252 | 0.272 | 7.8 |
| Example cyan | 0.101 | 0.101 | 0.0 |
| Example magenta | 0.124 | 0.130 | 4.8 |
| Example yellow | 0.188 | 0.181 | −3.6 |

The results shown in Tables 11 and 12 indicate that the stability of the example inkjet inks is suitable for inkjet printing.

It is to be understood that the ranges provided herein include the stated range and any value or sub-range within the stated range, as if they were explicitly recited herein. For example, a range from about 1 wt % to about 6 wt % should be interpreted to include not only the explicitly recited limits of from about 1 wt % to about 6 wt %, but also to include individual values, such as 2 wt %, 2.5 wt %, 3 wt %, 4 wt %, 4.7 wt %, 5 wt %, etc., and sub-ranges, such as from about 3 wt % to about 5 wt %, from about 2.5 wt % to about 4.5 wt %, from about 4 wt % to about 5.75 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet ink for textile printing, the inkjet ink comprising:
a self-dispersed pigment including a pigment and an organic group attached thereto, the organic group including at least one phosphorus-containing group;
a polyester-polyurethane binder; and
a liquid vehicle.

2. The inkjet ink as defined in claim 1 wherein:
the self-dispersed pigment is present in an amount ranging from about 1 wt % to about 6 wt % based on a total weight of the inkjet ink; and
the polyester-polyurethane binder is present in an amount ranging from about 4 wt % to about 10 wt % based on the total weight of the inkjet ink.

3. The inkjet ink as defined in claim 1, further comprising an additive selected from the group consisting of an anti-kogation agent, an anti-decel agent, a surfactant, a biocide, and a combination thereof.

4. The inkjet ink as defined in claim 1 wherein the liquid vehicle includes water and a co-solvent.

5. The inkjet ink as defined in claim 1 wherein the at least one phosphorus-containing group has at least one P—O bond or P═O bond.

6. The inkjet ink as defined in claim 5 wherein the at least one phosphorus-containing group is a phosphonic acid group, a partial ester thereof, or a salt thereof.

7. The inkjet ink as defined in claim 5 wherein the at least one phosphorus-containing group is a partial phosphonic acid ester group having a formula —PO₃RH, or a salt thereof, wherein R is an aryl, an alkaryl, an aralkyl, or an alkyl group.

8. The inkjet ink as defined in claim 5 the at least one phosphorus-containing group is a geminal bisphosphonic acid group having a formula —CQ(PO₃H₂)₂, or a salt thereof, wherein Q is selected from the group consisting of H, R, OR, SR, and NR₂, and wherein R is independently selected from the group consisting of H, a C₁-C₁₈ saturated or unsaturated, branched or unbranched alkyl group, a C₁-C₁₈ saturated or unsaturated, branched or unbranched acyl group, an aralkyl group, an alkaryl group, and an aryl group.

9. The inkjet ink as defined in claim 1 wherein the polyester-polyurethane binder is a sulfonated polyester-polyurethane binder, and is one of:
i) an aliphatic compound including multiple saturated carbon chain portions ranging from C₄ to C₁₀ in length, and that is devoid of an aromatic moiety; or
ii) an aromatic compound including an aromatic moiety and multiple saturated carbon chain portions ranging from C₄ to C₁₀ in length.

10. The inkjet ink as defined in claim 1 wherein the polyester-polyurethane binder has a weight average molecular weight ranging from about 20,000 to about 300,000.

11. The inkjet ink as defined in claim 1 wherein the polyester-polyurethane binder has an acid number ranging from about 1 mg KOH/g to about 50 mg KOH/g.

12. A printing method, comprising:
generating a print by thermal inkjet printing an inkjet ink directly onto a textile fabric selected from the group consisting of cotton, polyester, nylon, and silk, the inkjet ink including:
a self-dispersed pigment including a pigment and an organic group attached thereto, the organic group including at least one phosphorus-containing group;
a polyester-polyurethane binder; and
a liquid vehicle; and
thermally curing the print.

13. The printing method as defined in claim 12 wherein thermally curing the print involves heating the print to a temperature ranging from about 100° C. to about 180° C.

14. A textile printing kit, comprising:
a textile fabric selected from the group consisting of cotton, polyester, nylon, and silk; and
an inkjet ink to be printed on the textile fabric, the inkjet ink including:
a self-dispersed pigment including a pigment and an organic group attached thereto, the organic group including at least one phosphorus-containing group;
a polyester-polyurethane binder; and
a liquid vehicle.

15. The textile printing kit as defined in claim 14 wherein:
the self-dispersed pigment is present in an amount ranging from about 1 wt % to about 6 wt % based on a total weight of the inkjet ink;
the polyester-polyurethane binder is present in an amount ranging from about 4 wt % to about 10 wt % based on the total weight of the inkjet ink; and
the liquid vehicle includes water and a co-solvent present in an amount ranging from about 2 wt % to about 20 wt % based on the total weight of the inkjet ink.
